(19) United States
(12) Patent Application Publication
(10) Pub. No.: US 2006/0093068 A1
(43) Pub. Date: May 4, 2006

(54) DC WANDER CANCELING DEVICE AND METHOD

(76) Inventors: Tsu-Chun Liu, Hsinchu (TW); Ming-Lu Wu, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/906,500

(22) Filed: Feb. 23, 2005

(30) Foreign Application Priority Data
Oct. 29, 2004 (TW) 93132904

(51) Int. Cl. H04L 25/06; H04B 1/10

(52) U.S. Cl. 375/317; 375/350

(57) ABSTRACT

A DC wander canceling device is provided for canceling DC wander. The DC wander canceling device comprises an analog front end, an equalizer, a slicer, and a digital/analog DC wander canceller. The digital/analog DC wander canceller is coupled to the slicer and the analog front end for receiving a sliced signal. According to the difference of the received sliced signal and the input signal of the slicer, the digital/analog DC wander canceller compensates the equalized signal to cancel a digital DC wander, and also cancel an analog DC wander at the input of the analog front end, to enhance the accuracy of signal demodulation.

### CROSS-REFERENCE TO RELATED APPLICATION

This application claims the priority benefit of Taiwan application serial no. 93132904, filed on Oct. 29, 2004.

### BACKGROUND OF THE INVENTION

1. Field of the Invention

This invention generally relates to a level wander canceling circuit, and more particularly, to a signal level wander canceling circuit suitable for using in Ethernet-related technologies.

2. Description of Related Art

In general, during the process of signal transmission, regardless of wire form or wireless form, some external factors, such as the transmitting path or transmitting medium, would usually cause signal distortion at the receiving terminal. On the other hand, when a signal is received at the receiving terminal, the DC loss inside the transformer would possibly also cause the phenomenon of signal level wander.

When Ethernet chip is receiving the signal, the same phenomenon occurs also. As a result, when the Ethernet chip demodulates the signal, the level of the received signal might have been in wander, such that it would cause the error when the signal is demodulated.

In solution for the foregoing situation, some circuits are usually added to solve the problem. FIG. 1 shows a conventional DC wander canceling circuit. In FIG. 1, after the Ethernet chip receives the signal, a transformer 101 transmits the signal to an analog front end (AFE) 103 for fetching the signal, then the signal is transmitted to an equalizer 105 for filtering the signal, then the filtered signal is transmitted to a slicer 107 for slicing and outputting the quantified signal. A comparison processor 109 performs an error calculation between the signals before and after being sliced by subtraction the quantities, for example. Further, the result of the subtraction operation is transmitted to a DC level wander canceller 111 for further process. After getting the compensation value of the signal level, the compensated value is transmitted to the analog front end 103 for signal adjustment, to cancel the signal level wander phenomenon.

Though this method can solve the signal wander problem, for the process manner in the circuit, since the process path from the output of the slicer 107, to the DC wander canceller 111 and to the analog front end 103 for compensation process is too long, it causes a latency issue. Therefore, when the system performs canceling the DC wander, the system cannot achieve the performance for instant process.

FIG. 2 is a circuit block showing another conventional DC wander canceling circuit. As shown in FIG. 2, the whole process is similar to the process in FIG. 1, wherein both of them first uses the transformer 201 to transmit the signal to an analog front end (AFE) 203 to fetch the signal, then the signal is transmitted to an equalizer 205 for filtering, then the filtered signal is transmitted to a slicer 207 for slicing. Then, a comparison processor 209 receives the non-sliced signal and the sliced signal and performs a subtraction calculation, i.e. the sliced signal subtracts from the non-sliced signal. Then, the result of the subtraction calculation is transmitted to a DC wander canceling circuit 211 for further processing. The DC wander canceling circuit 211 then transmits the value of the subtraction calculation to an output terminal of an equalizer 205. In other words, the output signal of the digital DC wander canceling circuit 211 is added to the output terminal of the equalizer 205 to perform a digital DC wander compensation on the output of the equalizer 205.

In FIG. 2, the process path of canceling the DC wander is substantially reduced. That is, the output signal of the slicer 207, passes through the digital DC wander canceling circuit 211, and reaches the output terminal of the equalizer 205. Therefore, compared with the conventional circuit in FIG. 1, the path is reduced, and the latency effect caused by the path length is decreased substantially.

The structure in this situation focuses on the digital part in canceling the DC wander. That is to say, before the output signal of the equalizer 205 enters the slicer 207, a suitable compensation is performed on the output signal of the equalizer 205. Therefore, the slicer 207 can receive more accurate output signal of the equalizer 205, and performs the more accurate slicing process.

However, the process time of the analog front end 203 and the equalizer 205 are not equal, therefore error would still occur under this structure. Further, the efficiency of the dynamic range in an A/D converter of the analog front end 203 is also affected.

### SUMMARY OF THE INVENTION

An object of the present invention is to provide a signal level wander canceling circuit, for adjusting signal level of analog signal and digital signal simultaneously to cancel the DC wander at the reception end.

To achieve the above and other objects, the present invention provides a DC wander canceling device, for canceling DC wander. The DC wander canceling device comprises an analog front end for receiving a coded signal and performing demodulation in accordance with the coded signal; an equalizer, coupled to the output terminal of an analog front end, performing a equalizing filtering process and outputting the equalized signal; a slicer, coupled to the equalizer, performing a slicing process to the input signal of the slicer, and outputting the sliced signal; a digital/analog DC wander canceller, coupled to the slicer, receiving the difference value between the sliced signal and the input signal of the slicer, compensating the equalized signal according to the difference to cancel the digital DC wander, and canceling an analog DC wander for the input of the analog front end.

According to an embodiment of the present invention, the above mentioned digital/analog DC wander canceller further comprises a first operational unit, for receiving the difference value between the sliced signal and the input signal of the slicer, and generating a first compensation signal; a second operational unit, for receiving the difference value between the sliced signal and the input signal of the slicer, and generating a second compensation signal, and transmitting the second compensation signal to the analog front end to cancel the analog DC wander; a latency and amplitude balancer, coupled to the output terminal of the second operation unit, to perform balance of latency and amplitude in the second compensation signal and generate a balance signal. The balance signal is added with the first compensation signal, and then transmitted to the equalizer for compensating the equalized signal.

The above mentioned first operation unit further comprises a multiplying operation unit, for multiplying the difference value between the sliced signal and the input signal of the slicer by a first coefficient; an adding operation unit, for receiving the output of the multiplying operation unit and the output of a first integrator, and performing an adding operation; wherein the first integrator performs an integration operation on the output of the adding operation unit. The second operation unit further comprises a multiplying operation unit, for multiplying the difference value between the sliced signal and the input signal of the slicer by a second coefficient; an adding operation unit, for receiving the output of the multiplying operation unit and the output of a second integrator, and performing an adding operation; wherein the second integrator performs an integration on the output of the adding operation unit.

Further, the present invention provides a method for canceling DC wander. The method comprises detecting the output signal and the input signal of the slicer; calculating the difference value between the output signal and the input signal of the slicer; and performing the DC wander canceling process to the pre-level circuit of the slicer according to the difference value. Wherein, the input signal of the slicer is the output signal of the pre-level circuit with the DC wander canceled.

The present invention further provides a method for canceling the DC wander. The method comprises detecting the output signal and the input signal of the slicer; calculating the difference value between the output signal and the input signal of the slicer; performing the DC digital wander canceling process to the first pre-level circuit of the slicer according to the difference value, and performing the DC analog wander canceling process to the second pre-level circuit of the slicer, wherein the input signal of the slicer is the output signal of the pre-level circuit with the DC digital wander canceled.

In light of the above, the signal wander canceling circuit of the present invention can adjust the digital signal level wander before quantifying the signal, thus increasing the instant processing performance on the signals in the system. In the mean time, the analog signal level wander can be adjusted at the analog front end, thus avoiding over-flow when the signal is transformed in the A/D converter, and enhancing the accuracy of signal demodulation.

### BRIEF DESCRIPTION OF THE DRAWINGS

The above and other features of the present invention will be better understood from the following detailed description of the embodiments of the invention that is provided in combination with the accompanying drawings.

FIG. 1 is a circuit block showing a conventional signal level wander canceling circuit.

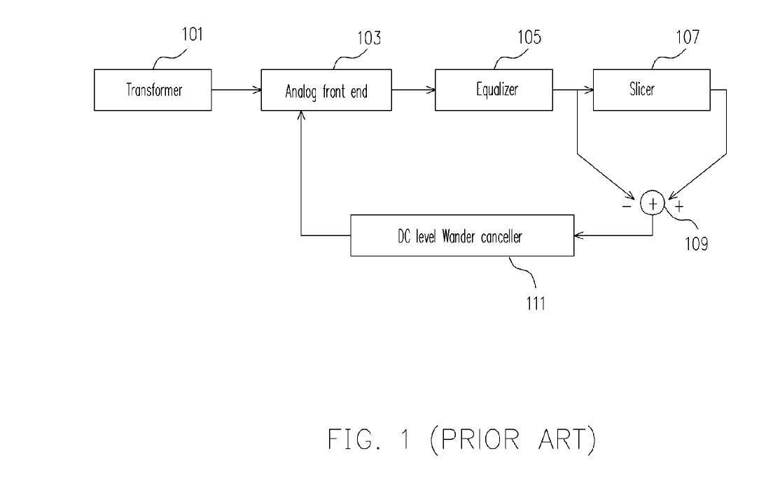

FIG. 2 is a circuit block showing another conventional digital signal level wander canceling circuit.

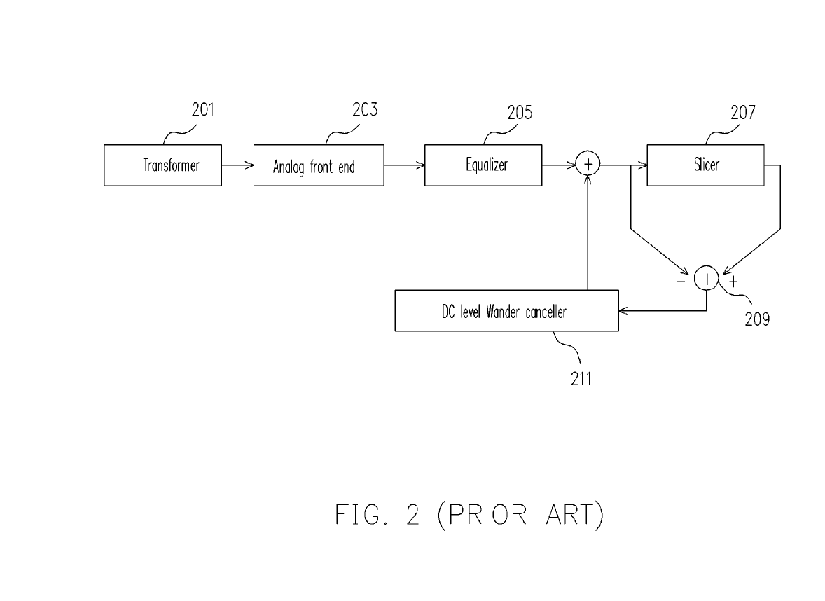

FIG. 3 is a circuit block showing a signal level wander canceling circuit in accordance with an embodiment of the present invention.

FIG. 4 is a circuit block showing another signal level wander canceling circuit in accordance with an embodiment of the present invention.

FIG. 5 is a flow chart showing the method of canceling the signal level wander in accordance with an embodiment of the present invention.

### DESCRIPTION OF THE EMBODIMENTS

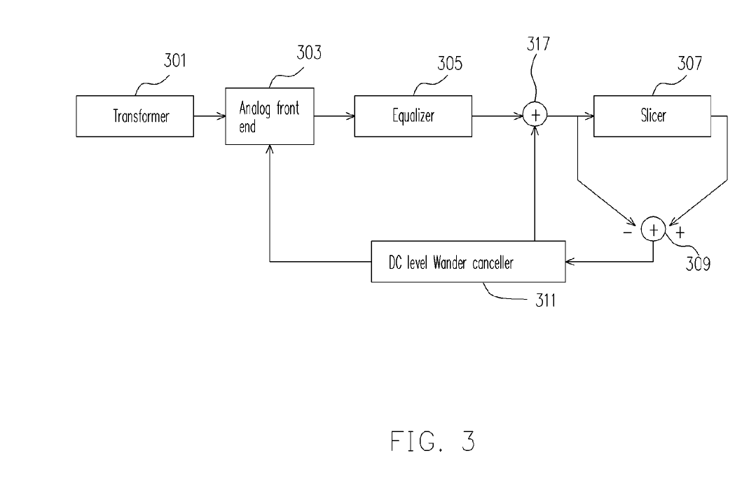

FIG. 3 is a circuit block showing a DC wander canceling circuit in accordance with an embodiment of the present invention. An analog signal, after received by an electronic device, such as Ethernet chip, is transmitted by a transformer 301 to an analog front end 303 for signal processing. The function of the analog front end 303 includes fetching the information from the signal transmitted by the transformer 301, analog filtering, analog/digital transforming, power amplifying, and transmitting the signal to an equalizer 305. The equalizer 305, after receiving the signal, can filter the inter-symbol interference (ISI) induced from multiple paths, and then transmits an equalized signal to an adder 317 for canceling digital DC wander in the equalized signal. Then, the signal is inputted to a slicer 307. The slicer 307 performs a slicing process to the compensated equalized signal, and outputs a sliced signal. Then, the input signal (the compensated equalized signal) and the output signal (the sliced signal) from the slicer 307 are transmitted to a comparison processor 309. Herein, the comparison processor 309 subtracts the compensated equalized signal from the sliced signal outputted from the slicer 307, and inputs the difference value to a digital/analog DC wander canceller 311.

Then, in accordance with the difference value of the slicing signal subtracted by the compensated equalized signal, the digital/analog DC wander canceller 311 calculates the wander compensating values of the digital portion and the analog portion, respectively, then outputs the values to an operation processor (adding processing) 317 and the analog front end 303. This circuit is described in the following.

In accordance with the circuit structure of the above mentioned embodiment, the digital/analog DC wander canceller 311 can perform the DC wander canceling process to both the output of the equalizer 305 and the input of the analog frond end 303. Therefore, the signal input to the slicer 307 can be more accurate, and the slicer 370 can output the required signal with more accuracy.

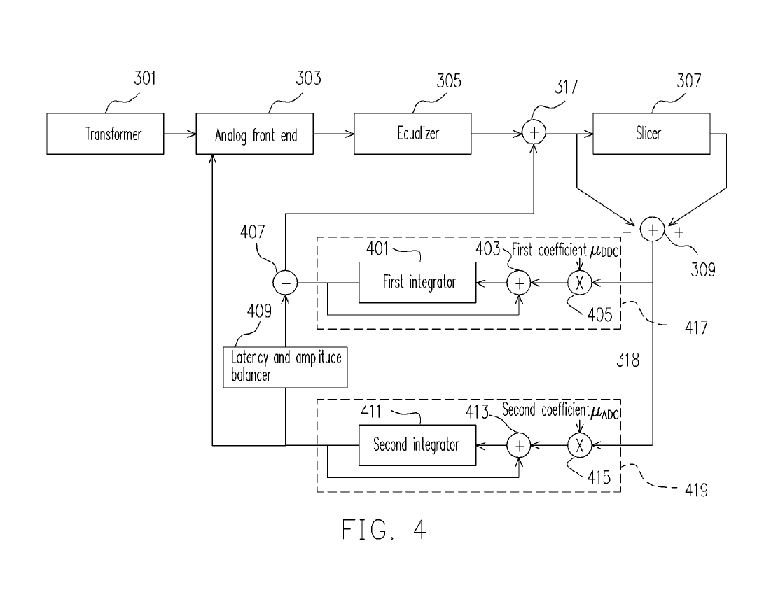

FIG. 4 is a circuit block showing another DC wander canceling circuit in accordance with an embodiment of the present invention, which better describes the inner circuit of the digital/analog DC wander canceller 311 in FIG. 3. As shown in FIG. 4, the digital/analog DC wander canceller 311 comprises a first operation unit 417, a second operation unit 419 and a latency and amplitude balancer 409. The first operation unit 417 includes a first integrator 401, an operation processor (addition processing) 403 and an operation processor (multiplication processing) 405. The second operation unit 419 includes a second integrator 411, an operation processor (addition processing) 413, an operation processor (multiplication processing) 415 and an operation processor (addition processing) 407.

The operation processor 309 calculates the difference value of the input and the output of the slicer 307, and the value is inputted to the first operation unit 417 and the second operation unit 419, respectively. At the first operation unit 417, the signal of input difference value is multiplied by a first coefficient μDDC by the operation processor (multiplication processing) 405, and the result is transmitted to the operation processor (addition processing) 403, and added with a compensated signal from the first integrator 401, then transmitted to the first integrator 401 for integration process, to generate a first compensation signal.

At the second calculator 419, the signal of input difference value is multiplied by a second coefficient μADC by the operation processor (multiplication processing) 415, and the result is transmitted to the operation processor (addition processing) 413, and added with a compensated signal of the second integrator 411, then is transmitted to the second integrator 411 for integration processing, to generate a second compensation signal. The second compensation signal outputted by the second integrator 411 is transmitted to the analog front end 303 for the DC wander canceling process in the analog portion.

Further, the second compensation signal outputted by the second integrator 411 is further transmitted to the latency and amplitude balancer 409, to generate a balance signal. The first compensation signal, outputted by the first integrator 401, and the balance signal, outputted by the latency and amplitude balancer 409, are added in the operation processor (addition processing) 407, and then transmitted to the operation processor (addition processing) 317. The compensation value of the digital/analog DC wander canceller 311 canceling the digital portion of the DC wander of the signal, is added to the output of the equalizer 305 through the operation processor 317 (addition processing), for performing the DC wander canceling compensation to the equalized signal outputted by the equalizer 305. The latency and amplitude balancer 409 compensates the differences of latency and amplitude between the equalizer 305 and the analog front end 303.

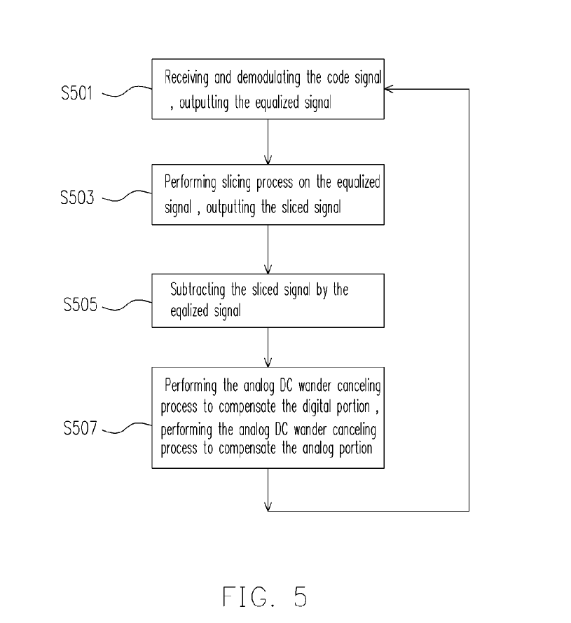

FIG. 5 is a flow chart showing the method of canceling the signal level wander in accordance with an embodiment of the present invention. First, in step S501, the coding signal is received and demodulated, then equalized to output the equalized signal. This step can be performed by, for example, the above mentioned analog front end and equalizer.

In step S503, the equalized signal is quantified to output the sliced signal. This step can be performed by, for example, the slicer of the above mentioned embodiments.

Then, in step S505, the equalized signal and the quantified signal are processed in operation. For example, the input and output of the slicer of the above mentioned embodiments are subtracted to each other to get the error value.

In step S507, the digital DC wander canceling process is performed. In accordance with the error value generated in step S505, the DC wander canceling processes to the digital portion and the analog portion are performed for compensating the output of the slicer and the input of the analog front end, respectively.

In view of the above mentioned, the signal wander canceling circuits of the present invention can adjust the digital signal wander before quantifying the signal, thus increasing the instant processing effect in the system. In the mean time, the signal wander canceling circuit of the present invention can adjust the analog signal level at the analog front end to avoid the over flow when the signal is processed in the A/D converter, to increase the accuracy during signal demodulation.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

What is claimed is:

1. A direct-current (DC) wander canceling device, for canceling a DC wander, the DC wander canceling device comprising:
an analog front end, for receiving a coding signal, and performing signal demodulation in accordance with the coding signal;
an equalizer, coupled to an output of the analog front end, for performing an equalizing filtering process, and outputting an equalized signal;
a slicer, coupled to the equalizer, for performing a slicing process to an input signal of the slicer, and outputting a sliced signal; and
a digital/analog DC wander canceller, coupled to the slicer, for receiving a difference value between the sliced signal and the input signal of the slicer, for performing a compensation process to the equalized signal in accordance with the difference value so as to cancel a digital DC wander, and performing an analog DC wander canceling process to the input of the analog front end.

2. The DC wander canceling device of claim 1, wherein
the digital/analog DC wander canceller further comprises:
a first operation unit, for receiving the difference value between the sliced signal and the input signal of the slicer to generate a first compensation signal;
a second operation unit, for receiving the difference value between the sliced signal and the input signal of the slicer to generate a second compensation signal, and transmitting the second compensation signal to the analog front end, to cancel the analog DC wander; and
a latency and amplitude balancer, coupled to an output terminal of the second operation unit, for balancing the latency and amplitude to the second compensation signal to generate a balance signal;
wherein the balance signal is added with the first compensation signal, and transmitted to the equalizer to compensate the equalized signal.

3. The DC wander canceling device of claim 2, wherein the first operation unit further comprises:
a first integrator;
a multiplication operation unit, for multiplying the difference value between the sliced signal and the input signal of the slicer by a first coefficient; and
an addition operation unit, for receiving an output of the multiplication operation unit and an output of the first integrator, and performing an addition operation;
wherein the first integrator performs an integration operation to the output of the addition operation unit.

4. The DC wander canceling device of claim 2, wherein the second operation unit further comprises:
a second integrator;
a multiplication operation unit, for multiplying the difference value between the sliced signal and the input signal of the slicer by a second coefficient; and
an addition operation unit, for receiving the output of the multiplication operation unit and the output of the second integrator, and performing an addition operation; wherein the second integrator performs an integrating operation to the output of the addition operation unit.

5. A direct-current (DC) wander canceling device, wherein the characteristics comprises: performing the DC wander canceling process to a pre-level circuit of a slicer, in accordance with a difference value between an output signal and an input signal of the slicer.

6. The DC wander canceling device of claim 5, wherein the pre-level circuit comprises an equalizer, and the DC wander canceling device performs a digital DC wander canceling process to the output of the equalizer.

7. The DC wander canceling device of claim 5, wherein the pre-level circuit further comprises an analog front end, and the DC wander canceling device performs a analog DC wander canceling process to the analog front end.

8. A direct-current (DC) wander canceling method, comprising:
detecting an output signal and an input signal of a slicer;
calculating a difference value between the output signal the input signal of the slicer;
performing a DC digital wander canceling process to a first pre-level circuit with respect to the slicer in accordance with the difference value, and performing a DC analog wander canceling process to a second pre-level circuit with respect to the slicer, wherein the input signal of the slicer is the output signal of the first pre-level circuit with the DC digital wander canceled.
